(19) United States
(12) Patent Application Publication
(10) Pub. No.: US 2018/0047308 A1
(43) Pub. Date: Feb. 15, 2018

(54) File Folder with removable / peelable label(s) / tab(s)

(71) Applicant: Andrew Fontelar Dioneda, Sparta, NJ (US)

(72) Inventor: Andrew Fontelar Dioneda, Sparta, NJ (US)

(21) Appl. No.: 15/675,033

(22) Filed: Aug. 11, 2017

(30) Foreign Application Priority Data
Aug. 11, 2016 (US) 62373711

(51) Int. Cl. G09F 3/00; G09F 3/02; B42F 21/06

(52) U.S. Cl. CPC G09F 3/0288; B42F 21/06; G09F 3/02; G09F 2003/023; G09F 2003/0257

(57) ABSTRACT

This invention relates to file folders with one, two, or more layers of removable or peelable labels that are pre-adhered, pre-stuck to the tab. This invention allows an individual to re-use a file folder one, two or more times notwithstanding that the file folder tabs have been marked. Individuals will also have the opportunity to continue using the folder even if he/she makes mistakes writing on the tabs/labels. By peeling off or removing a layer of a pre-existing, pre-adhered, non-stainable label, the individual can re-use the same file folder but with a new, fresh, clean, and unmarked tab/label. Because of its reuseability, it will help cut down on the amount of paper waste we throw away.

For purposes of this invention, file folder includes, but are not limited to, or are and can be referred to, as straight or numbered cuts, side or end tabs, letter or legal size, manila, recycled or colored, or with fastener, and expanding jackets or pockets. The present invention provides pre-adhered, non-stainable one, two or more removable/peelable layers of label on the tab of the file folder. The layers of label are a bit different from one another such that the top layer is a tad longer than the layer beneath it or if it's the same size, a tiny fraction at the side of the labels will not have adhesive. These labels are placed on the tab by labeling machines or similar equipment.

The labels are non-stainable and can handle ball point pens, pencils, board and permanent markers and other writing instruments.

The sticking or adhesive quality of the pre-adhered, non-stainable label is akin to the adhesiveness of the Post-It® labeling and correction & cover-up tape manufactured by 3M® such that when the first layer is removed or peeled off, the layer underneath remains and when peeled, it would not damage or leave residue to the label underneath or to the skin of the file folder tab.

The top label can be peeled off after it serves its first use and the file folder can be reused with a new label on the tab and so forth.

### DESCRIPTION OF DRAWINGS

As referred to in the Summary or Description above, for purposes of this invention, file folder includes, but are not limited to, or are and can be referred to, as straight or numbered cuts, side or end tabs, letter or legal size, manila, recycled or colored, or with fastener, and expanding jackets or pockets. The drawings henceforth shows a ⅓ cut file folder with end tab (FIGS. 1-10) and a straight cut folder (FIGS. 11-18).

FIG. 1 is dimensional position of ⅓ cut manila file folder with no labels on the tab.

FIG. 2 is overblown drawing of the tab of ⅓ cut manila file folder without the labels.

FIG. 3 is overblown drawing of the tab of a ⅓ cut manila file folder with two layers of labels.

FIG. 4 is overblown drawing of the tab of ⅓ cut manila file folder showing first label peeled at the lower right corner. The second layer of label can be seen under the peeled part of the first label and still glued to the folder tab.

FIG. 5 is overblown drawing of the tab of ⅓ cut manila file folder showing first label peeled half way through and second label remains and unpeeled.

FIG. 6 is overblown drawing of the tab of ⅓ cut manila file folder showing first label peeled half way through and second label is peeled at the lower right corner.

FIG. 7 is overblown drawing of the tab of ⅓ cut manila file folder showing first layer of the label peeled more than half way through and second label peeled halfway through.

FIG. 8 is overblown drawing of the tab of ⅓ cut manila file folder showing just the second layer of label.

FIG. 9 is overblown drawing of the tab of ⅓ cut manila file folder showing the second layer of label peeled half way through.

FIG. 10 is drawing of dimensional position of ⅓ cut manila file folder showing two layers of labels.

FIG. 11 is drawing of straight cut manila file folder without the labels.

FIG. 12 is drawing of straight cut manila file folder with two layers of labels.

FIG. 13 is drawing of straight cut manila file folder showing the first label peeled at the lower right corner and the second layer of label underneath the peeled part of the first label.

FIG. 14 is drawing of straight cut manila file folder showing first label peeled half way through while second label remains in place and unpeeled.

FIG. 15 is drawing of straight cut manila file folder showing first label peeled half way through and second label is peeled at the lower right corner.

FIG. 16 is drawing of straight cut manila file folder showing first layer of the label peeled more than half way through and second label peeled a quarter through.

FIG. 17 is drawing of straight cut manila file folder showing the second layer of label.

FIG. 18 is drawing of straight cut manila file folder showing the second layer of label peeled half way through.

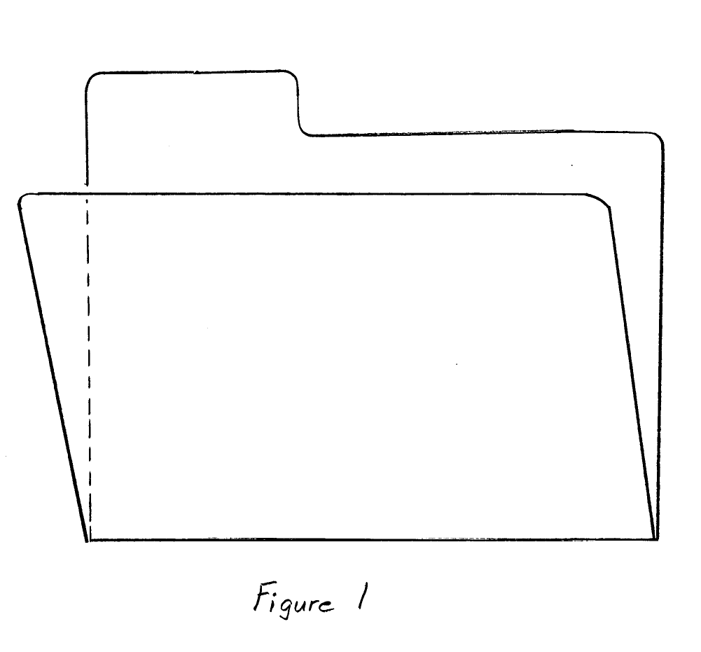

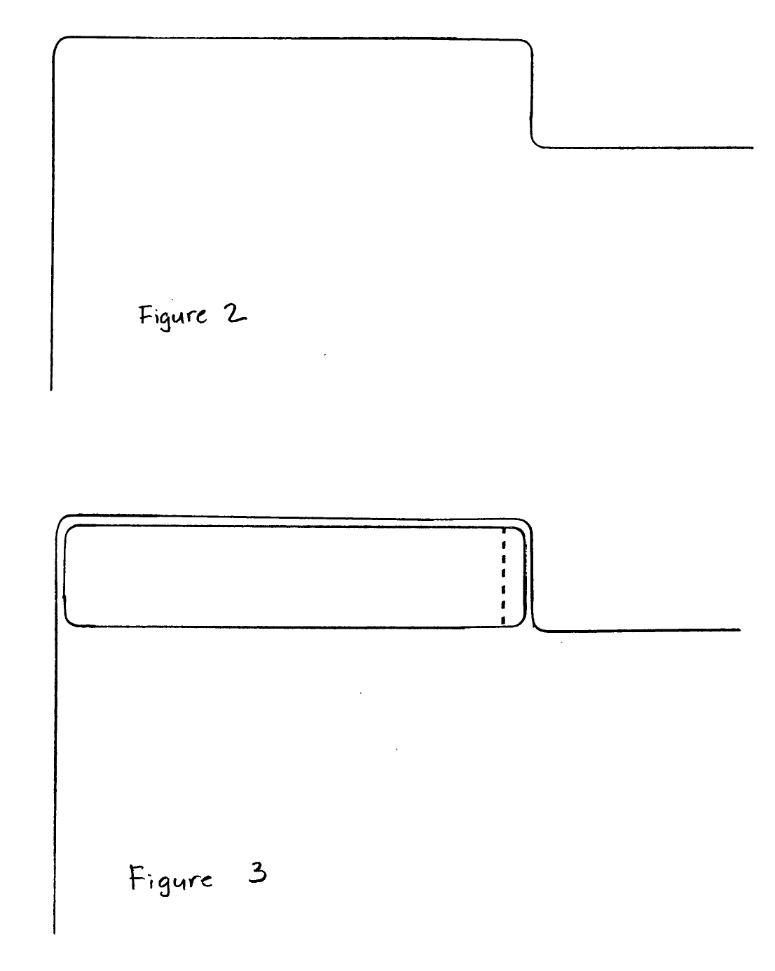

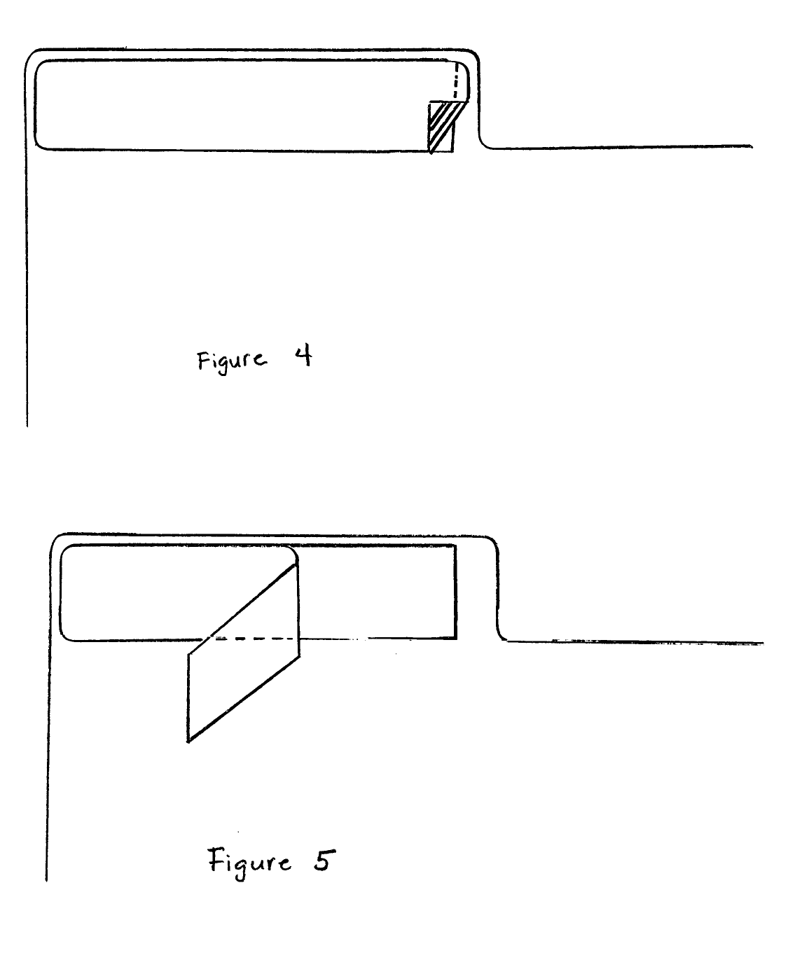

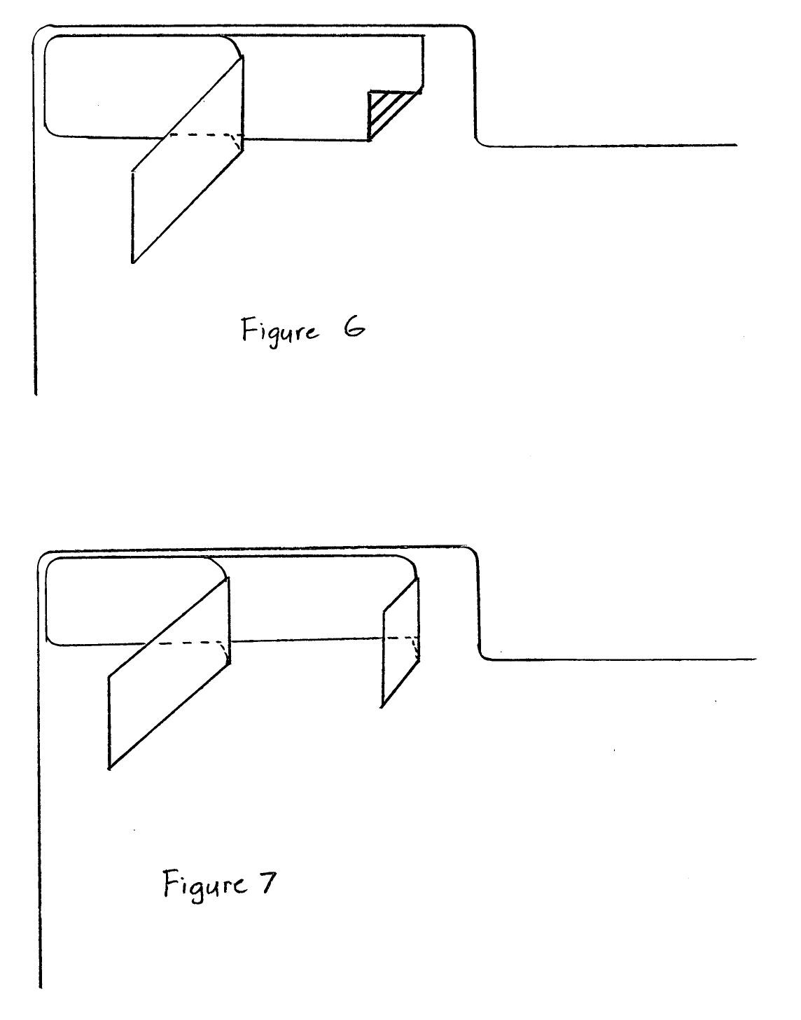

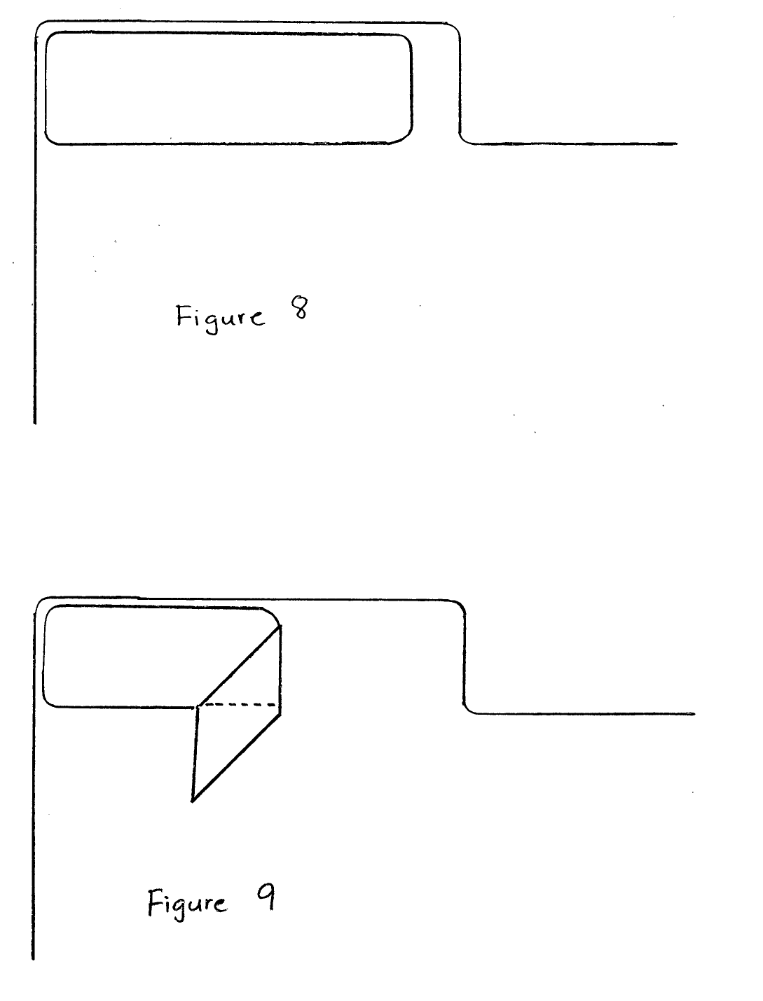

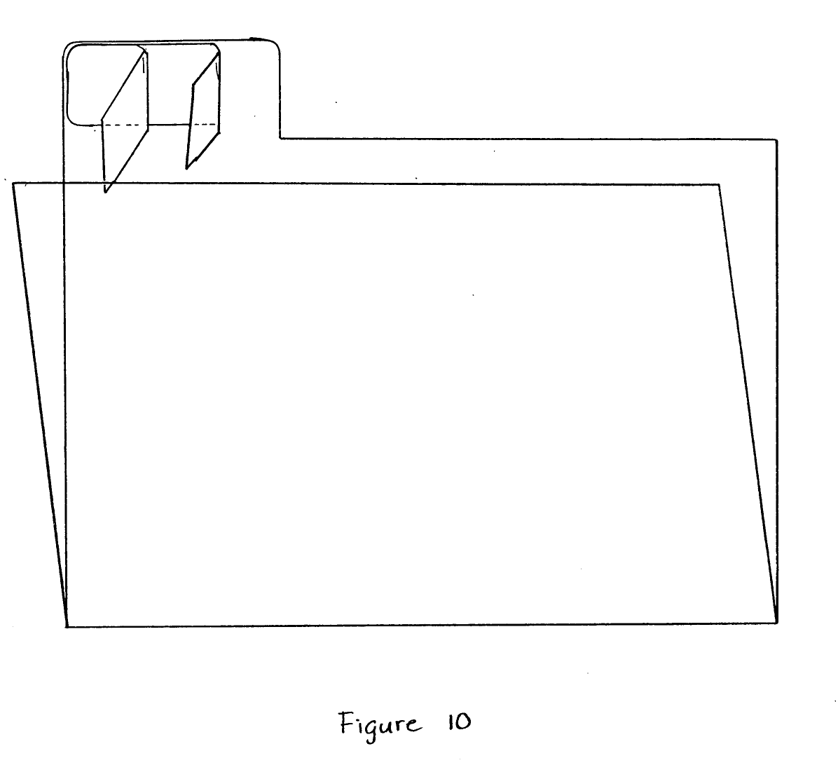

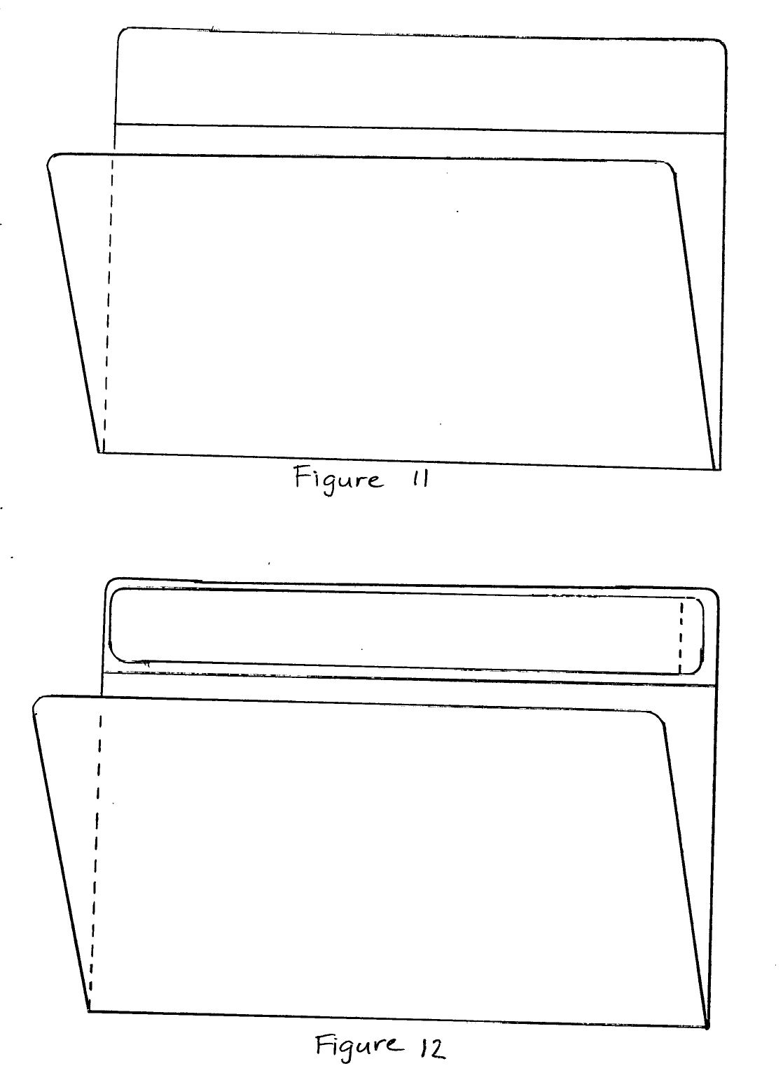

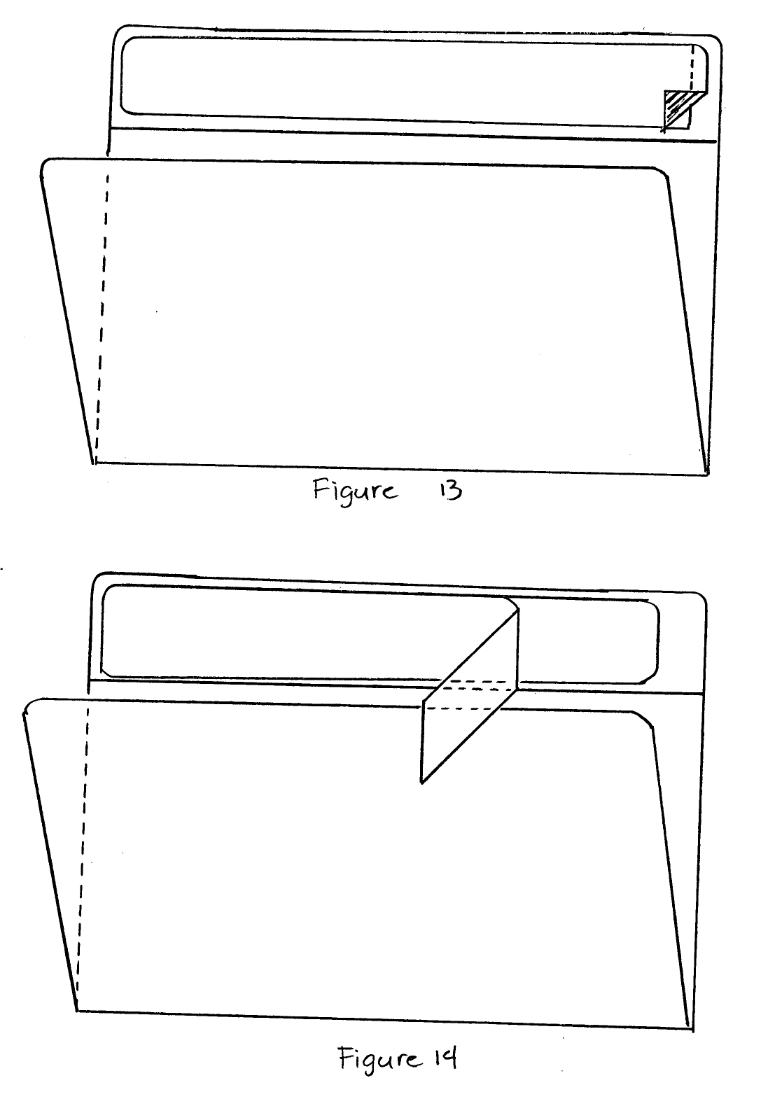

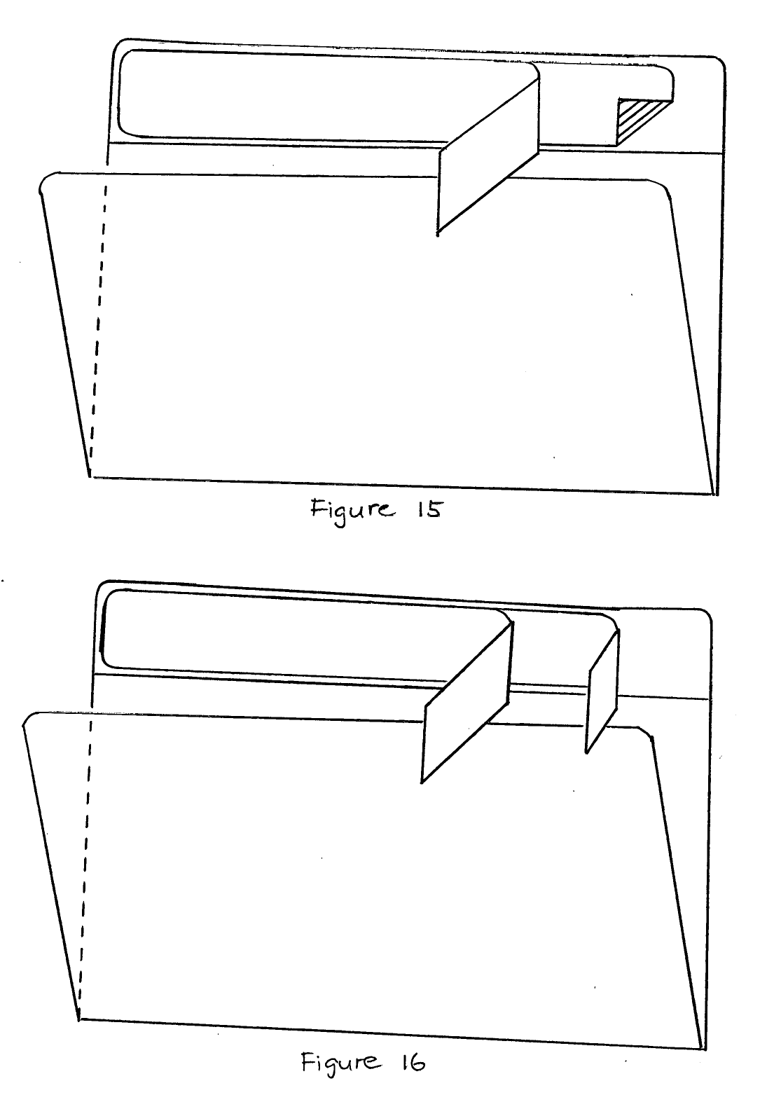

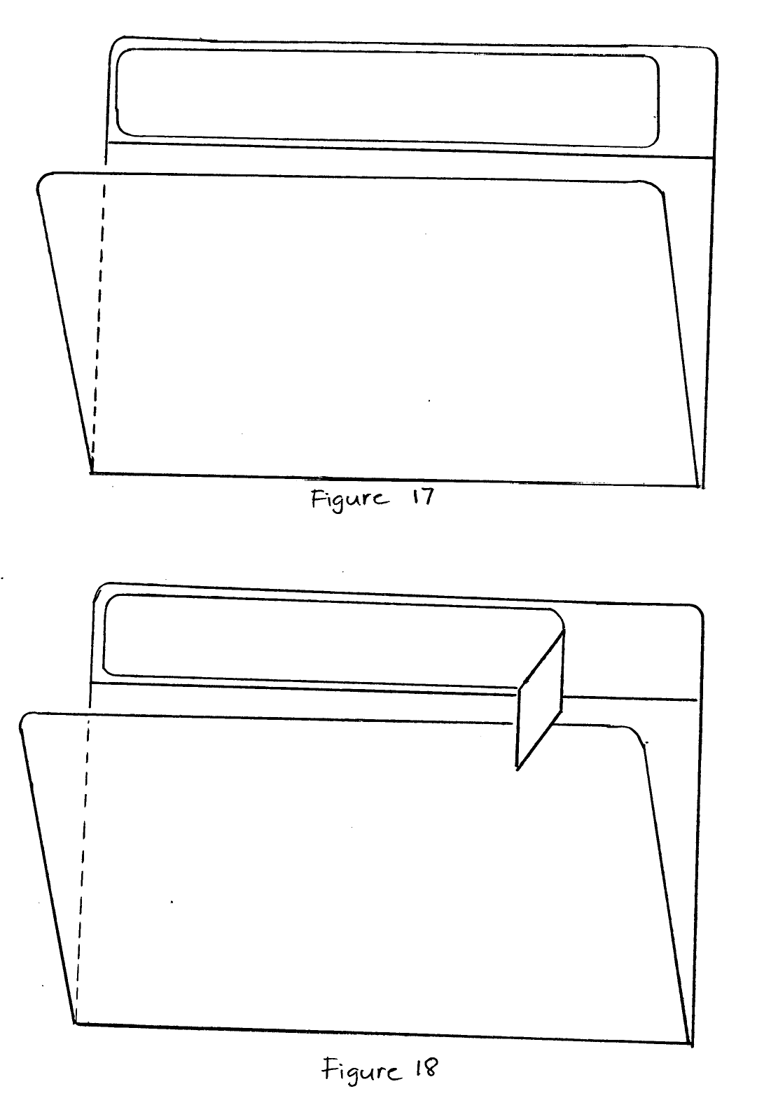

### BACKGROUND

File folders are generally discarded after one use. File folders today are not made or designed to be used two or more times. Once the tab of the file folder has been marked, written upon, compromised, or damaged, the file folder ends up in the thrash even if the file folder is in good shape. Erasing the writing on the tab is often times inconvenient and leaves unsightly, sloppy and messy erasure markings that makes the file folder unappealing and not presentable.

In lieu of writing on the tab, some use separate adhesive labels (i.e. Avery® labels) to write the file name and stick it on the tab. The problems with using a separate label are: 1) There is no label big enough to cover the entire length of the tab of some file folders (i.e. straight cut folders); and 2) The individual has to buy these labels separately that costs additional expense.

This present invention solves these problems by having pre-adhered, non-stainable, removable and peelable layer(s) of label along the tab of the folder. By using these labels, individuals can write on and peel the labels, and keep reusing the file folder.

1. The present invention provides pre-adhered, non-stainable one, two or more removable/peelable layers of label on the tab, whether a straight cut or numbered (i.e. ⅓, ⅕, ⅛, etc.) cut, of file folders. Each layer of label is a bit different from another such that the top layer is a tad longer than the layer beneath it or the labels will have the same size provided that a tiny fraction at the side of the labels do not have adhesive.

2. As to the labels in claim number 1, the sticking or adhesive quality of the pre-adhered, non-stainable label is akin to the adhesiveness of the Post-It® labeling and correction & cover-up tape manufactured by 3M® such that when the first layer is removed or peeled off, the layer underneath remains and when peeled, it would not damage or leave residue to the label underneath or to the skin of the file folder tab. The removable labels can be white or a different single color or a mix thereof.
